(19) United States
(12) Patent Application Publication
(10) Pub. No.: US 2021/0019568 A1
(43) Pub. Date: Jan. 21, 2021

(54) INFORMATION PROCESSING SYSTEM AND INFORMATION PROCESSING METHOD

(71) Applicant: HITACHI, LTD., Tokyo (JP)

(72) Inventors: Sayaka KURATA, Tokyo (JP); Naomi INADA, Tokyo (JP)

(73) Assignee: HITACHI, LTD., Tokyo (JP)

(21) Appl. No.: 16/928,591

(22) Filed: Jul. 14, 2020

(30) Foreign Application Priority Data
Jul. 16, 2019 (JP) 2019-131085

(51) Int. Cl. G06K 9/62; G06K 9/46; G06T 7/00; G06T 7/49; G06N 20/00; G06N 5/04

(52) U.S. Cl. CPC G06K 9/6257; G06K 9/6253; G06K 9/6263; G06K 9/46; G06K 9/00127; G06T 7/49; G06N 20/00; G06N 5/04; G06T 7/0004

(57) ABSTRACT

Image analysis using machine learning technology utilizes a texture structure which is analyzed while a manufacturing process is changed for a purpose of searching for an optimum condition or the like. One aspect is an information processing system including: an identifier configured to output an identification result with an image as input; an automatically identifiable range storage unit configured to store an identifiable range of the identifier defined by numerical values in n (n is an integer of 1 or more) dimensions; an acquisition unit configured to acquire the numerical values corresponding to the image; a control unit configured to compare the numerical values acquired by the acquisition unit and the identifiable range; and an alert output unit configured to output an alert when the control unit determines that the numerical values acquired by the acquisition unit deviate from the identifiable range.

### BACKGROUND OF THE INVENTION

### 1. Field of the Invention

The present invention relates to an information processing technique, and more particularly to an image analysis technique using machine learning.

### 2. Description of the Related Art

In related art, for example, in order to identify a composition and optical anisotropy of a material structure acquired with a microscope, or the like, the identification is general performed via visual confirmation. In this case, it is difficult to make an accurate determination due to a difference in recognition between persons and influence of surrounding environment. In addition, a burden to a worker and a cost are also a problem.

Research and development of image processing technology using an identifier are progressing along with recent improvement of computer performance, especially of artificial intelligence (AI) technology. In an identifier using a hierarchical neural network, which is a typical technology in this field, a process referred to as machine learning that constructs a model that matches a target process by optimizing a weight of connection of the hierarchical neural network is performed.

The machine learning using the hierarchical neural network can be broadly divided into supervised learning and unsupervised learning. In the supervised learning, a database is constructed (hereinafter, referred to as a “training database”) by using a set of pairs of an input x and a correct output t corresponding thereto as learning data (hereinafter, referred to as a “training data set”). In the machine learning, the weight of the connection of the hierarchical neural network is adjusted by using the training database, so that an output when a predetermined input is made to the hierarchical neural network approaches a correct answer. A properly learned model can output a correct answer with high accuracy to an input.

Relating to the machine learning, PTL 1 describes “a method of segmenting images of biological specimens using adaptive classification to segment a biological specimen into different types of tissue regions”.

PTL 2 describes “a technique that suppresses adverse effects of over-learning and reduces probabilities of misclassification by performing learning using training data supplemented together with training data based on training images”.

A texture structure, such as a form of crystal grains and precipitates forming a material, is related to properties of the material. On the other hand, the texture structure changes according to manufacturing processes. Here, a term “manufacturing process” is a concept that includes composition conditions of the material and processing conditions such as a heat treatment and a pressure treatment performed for manufacturing the material In order to quantitatively analyze a correlation between the material properties or the manufacturing processes and the texture structure, it is necessary to quantitatively analyze the texture structure.

Inventors considered to use an identifier to which the machine learning technique is applied for analyzing the texture structure from an image of the material observed with an electron microscope or the like. In order to generate an identifier by supervised learning, a training data set for associating the image with the texture structure included in the image is required.

What is required for the training data set is quantity and quality. That is, it is desirable that the training data set covers a wide range of image patterns of the material that are may be processed, and that appropriate correct answers are given to the patterns.

However, in a field of research and development, it is necessary to analyze the texture structure while the manufacturing process is changed for a purpose of searching for an optimum condition or the like. In this case, it is assumed that the texture structure changes as a search progress.

Therefore, in order to analyze the texture structure of an entire search region, it is practically difficult to prepare in advance the training data set that covers the wide range of the images of the materials that may be processed. Insufficient quantity and quality of the training data set will result in poorly learned identifiers.

Then, it becomes a problem to make image analysis using machine learning technology easy even when the texture structure is analyzed while the manufacturing process is changed for a purpose of searching for an optimum condition or the like.

### SUMMARY OF THE INVENTION

One preferred aspect of the invention is an information processing system including: an identifier configured to output an identification result with an image as input; an automatically identifiable range storage unit configured to store an identifiable range of the identifier defined by numerical values in n (n is an integer of 1 or more) dimensions; an acquisition unit configured to acquire the numerical values corresponding to the image; a control unit configured to compare the numerical values acquired by the acquisition unit and the identifiable range; and an alert output unit configured to output an alert when the control unit determines that the numerical values acquired by the acquisition unit deviate from the identifiable range.

Another preferred aspect of the invention is an information processing method for identifying an image by using an identifier learned by supervised machine learning, the information processing method including: a first step of storing an identifiable range of the identifier defined by numerical values in n (n is an integer of 1 or more) dimensions, and acquiring the numerical values corresponding to the image; a second step of comparing the acquired numerical value with the identifiable range; and a third step of notifying a user when it is determined that the acquired numerical values deviate from the identifiable range.

In a specific embodiment to be described later, the used numerical values are the feature amount of the identification result of the identifier. In another specific embodiment, the numerical values are the feature amount of the image. In another specific embodiment, the numerical value is at least one of a composition condition and a processing condition of a sample from which the image is acquired.

An image analysis using machine learning technology becomes easy even when a texture structure is analyzed while a composition or a manufacturing process is changed for a purpose of searching for an optimum condition or the like.

### BRIEF DESCRIPTION OF THE DRAWINGS

FIG. 1 is a configuration block diagram of a texture structure analysis system according to an embodiment.

FIG. 2 is a flowchart showing an overall image of a sample automatic analysis process according to the embodiment.

FIG. 3 is a detailed flowchart of training data set preparation S1000.

FIG. 4 is an image diagram showing an example of a training data image α and a labeling image β.

FIG. 5 is an image diagram showing an example in which a texture image of the sample changes.

FIG. 6 is a detailed flowchart of automatically identifiable range determination S2000.

FIG. 7 is a conceptual diagram showing a concept of determining the automatically identifiable range.

FIG. 8 is a flowchart showing details of a texture identification execution S4000.

FIG. 9 is an image diagram showing an example of a GUI display.

FIG. 10 is a detailed flowchart of re-identification preparation process S4100.

FIG. 11 is a detailed flowchart of automatically identifiable range determination S2000a according to a second embodiment.

FIG. 12 is a conceptual diagram showing another concept of determining the automatically identifiable range.

FIG. 13 is a flowchart showing details of a texture identification executing process S4000a.

### DESCRIPTION OF THE PREFERRED EMBODIMENTS

Embodiments will be described in detail with reference to the drawings. However, the invention should not be construed as being limited to description of the embodiments described below. Those skilled in the art could have easily understood that specific configurations can be changed without deviating from the spirit or gist of the invention.

In the configurations of the invention to be described below, the same part or a part having similar functions are denoted by same reference numerals in common among the different drawings, and a repetitive description thereof may be omitted.

When there are a plurality of elements having same or similar functions, the same reference numerals may be given with different subscripts. However, when there is no need to distinguish between the plurality of elements, the subscripts may be omitted.

Terms “first”, “second”, “third”, or the like in the present specification are used to identify components, and do not necessarily limit a number, an order, or contents thereof. Numbers for identifying components may be used on a context basis, and a number used in one context may not necessarily indicate the same configuration in another context. Further, the components identified by a certain number do not interfere with functions of the components identified by other numbers.

In order to facilitate understanding of the invention, a position, a size, a shape, a range, or the like of each configuration shown in the drawings may not represent an actual position, size, shape, range, or the like. Therefore, the invention is not necessarily limited to the position, the size, the shape, the range, or the like disclosed in the drawings.

The publications, patents, and patent applications cited herein constitutes part of the description of the present specification as it is.

Constituent elements in the present specification represented in singular forms are intended to include the plural, unless the context clearly indicates otherwise.

### First Embodiment

### <1. System Configuration>

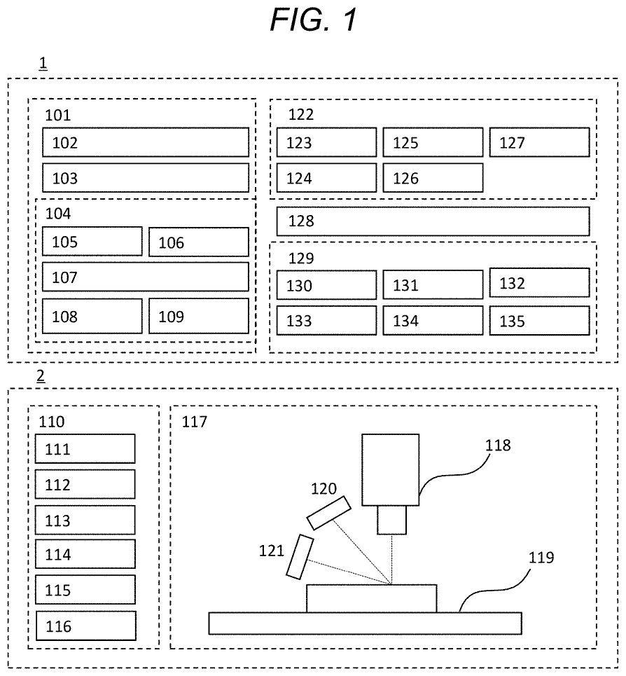

FIG. 1 is a configuration block diagram of a texture structure analysis system according to an embodiment. This system includes a texture structure analysis device 1 and an observation device 2.

The texture structure analysis device 1 basically includes an information processing device such as a server. As a basic configuration, the device includes, similar as a general server, an input device, an output device, a processing device, and a storage device.

In the present embodiment, functions such as calculation and control are implemented by the processing device executing a program stored in the storage device in cooperation with another hardware in predetermined processing. A program executed by a computer or the like, a function thereof, or means for implementing the function, in addition to a part or all of the storage devices that store data or databases may be referred to as a “portion”, a “function”, a “unit”, or the like.

Further, a configuration of the information processing device may include a single server, or any part of the input device, the output device, the processing device and the storage device may include a plurality of information processing devices connected by a network or the like. In the present embodiment, functions equivalent to functions including a software can also be implemented by hardware such as a field programmable gate array (FPGA) and an application specific integrated circuit (ASIC).

A physical configuration of the texture structure analysis device 1 is as described above, but is shown in FIG. 1 as a functional block diagram focusing on functional features. The main components are a texture structure analysis unit 101, a data storage unit 122, a correlation analyzer 128, and an input/output unit 129.

The texture structure analysis unit 101 includes an overall control unit 102, a texture data analysis unit 103, and a texture structure quantification unit 104 as functions to be executed with the software by the texture structure analysis device 1 and a function to store information. The overall control unit 102 controls overall functions of the texture structure analysis device 1. The texture data analysis unit 103 provides a function for creating a labeling image from a sample image or the like.

The texture structure quantification unit 104 includes a texture identifier 105, a training data set storage unit 106, a feature amount calculation unit 107, an automatically identifiable range determination unit 108, and an automatically identifiable range storage unit 109.

The texture identifier 105 is, for example, an identifier including a hierarchical neural network or the like learned by machine learning or the like, and automatically generates the labeling image from the sample image or the like. In this specification and the like, the sample image or the like from which the labeling image is generated may be referred to as an “original image” or a “data image”. Further, when terms including the “original image”, the “data image”, and the “labeling image” are mentioned, not only the image itself but also a concept of the image data for creating the image are included.

The training data set storage unit 106 stores a training data set for the machine learning. The feature amount calculation unit 107 calculates a feature amount from the labeling image. The automatically identifiable range determination unit 108 determines a range in which the texture identifier 105 can perform automatic identification. The automatically identifiable range storage unit 109 stores a range in which the texture identifier 105 can perform the automatic identification.

The data storage unit 122 including a magnetic disk device, or a semiconductor storage device, or a combination thereof, includes a sample information storage unit 123, a coordinate information storage unit 124, an image data storage unit 125, a texture identification result storage unit 126, and a feature amount storage unit 127 as a data storage regions.

The sample information storage unit 123 stores information related to a sample corresponding to the original image. The coordinate information storage unit 124 stores information related to a coordinate of the sample corresponding to the original image. The image data storage unit 125 stores the original image. The texture identification result storage unit 126 stores the labeling image. The feature amount storage unit 127 stores a feature amount of the labeling image.

The input/output unit 129 includes a well-known input device such as a keyboard and a mouse, and a well-known output device such as an image display device. However, other functions such as a printing function and a communication function may be provided.

The present embodiment includes a sample information input unit 130, a label data input unit 131, a determination input unit 132, an image display unit 133, an alert output unit 134, and an analysis result display unit 135 as units functionally specifying the input/output unit 129.

The sample information input unit 130 is an interface for inputting information related to a sample stored in the sample information storage unit 123. The label data input unit 131 is an interface for inputting the labeling image stored in the texture identification result storage unit 126. The determination input unit 132 is an interface for inputting a determination as to whether to re-learn the texture identifier 105. The image display unit 133 is, for example, an image display that displays desired information. The alert output unit 134 outputs an alert in a case of deviating from the range in which the texture identifier 105 can perform the automatic identification. The analysis result display unit 135 displays an analysis result of the correlation analyzer 128.

The correlation analyzer 128 analyzes a correlation between the feature amount stored in the feature amount storage unit 127 and the information related to the sample stored in the sample information storage unit 123. It is assumed that all of the data stored in the data storage unit 122 are associated with each other by, for example, an ID (identification information) of the original image. The ID of the original image preferably corresponds to, for example, a sample number and a coordinate (for example, an address) on the sample. When composition is uniform in one sample, the sample number may be used alone. When only one sample is present, the sample may be specified only by the coordinate on the sample.

In the present embodiment, the observation device 2 is assumed to be an electron microscope such as a scanning electron microscope (SEM). The observation device 2 includes a photographing condition setting unit 110 and a photographing unit 117.

The photographing condition setting unit 110 includes a beam control unit 111 that controls an electron beam, a detector control unit 112 that controls a first signal detection unit 120 and a second signal detection unit 121, a stage control unit 113 that controls a stage 119, a first signal acquisition unit 114 that acquires a signal from the first signal detection unit 120, a second signal acquisition unit 115 that acquires a signal from the second signal detection unit 121, and an image forming unit 116 that images the acquired signal.

The photographing unit 117 includes an electron beam generation unit 118, the stage 119 on which a sample is placed, the first signal detection unit 120, and the second signal detection unit 121. In the present embodiment, the first signal detector 120 detects energy of reflected electrons from the sample. The second signal detection unit 121 detects characteristic X-rays generated from the sample by electron beam irradiation. In the present embodiment, the second signal detection unit 121 can perform energy dispersive X-ray analysis (EDX), and can perform an elemental analysis and a composition analysis of the sample. Alternatively, the second signal detection unit 121 may be a unit that can detect based on other principles, such as an electron probe x-ray micro analyzer (SPMA) and an electron backscatter diffraction (EBSD).

In addition to the electron microscopes described above, the invention can be applied to various types of observation devices such as a polarization microscope, an atomic force microscope, and a kerr effect microscope.

### <2. Overall Process Flow>

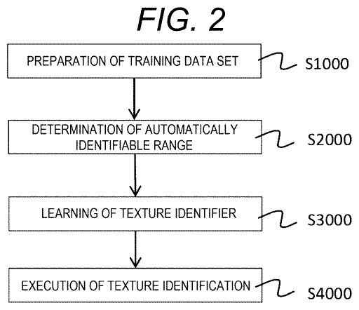

FIG. 2 is a flowchart showing an overall image of a sample automatic analysis process performed by the texture structure analysis system according to the present embodiment. Training data set preparation S1000, automatically identifiable range determination S2000, texture identifier learning S3000, and texture identification execution S4000 are included. Note that an order of automatic identification range determination S2000 and texture identifier learning S3000 may be reversed.

In the following embodiments, all processes in S1000 to S4000 are performed by the texture structure analysis device 1 and the observation device 2 for explanation, but these processes can also be performed independently by independent devices.

An example suitable for applying the present embodiment will be described for understanding the invention. The present embodiment can be used for, for example, research and development of materials and components. In the research and development of the materials, if a correlation between a manufacturing process of a material and a texture structure of the material is found, and once a correlation between the texture structure of the material and material characteristics is found, a guide as to which the manufacturing process should be changed to obtain desired characteristics can be obtained. For example, if a heating time of the manufacturing process is correlated with a ratio of a phase A in the texture structure, and the ratio of the phase A is correlated with hardness of the material, it is speculated that the heating time of the manufacturing process is useful for controlling the hardness of the material.

At this time, it is necessary to quantitatively evaluate the texture structure as an explanatory variable. For this reason, the original image obtained by photographing the texture structure is labelled, and the feature amount from the labeling image can be quantitatively obtained. Then, in order to label the original image, it is preferable to use the texture identifier using the machine learning in terms of development efficiency.

However, since it is necessary to analyze the texture structure while a composition and the process are changed, it is assumed that the texture structure changes as a search progresses. For this reason, it is difficult to prepare in advance a quantity and quality required for the training data set used for the machine learning. According to the embodiment described below, it becomes a problem to enable image analysis using machine learning technology even when the texture structure is analyzed while the composition and the process are changed for a purpose of searching for an optimum condition or the like.

### <3. Training Data Set Preparation S1000>

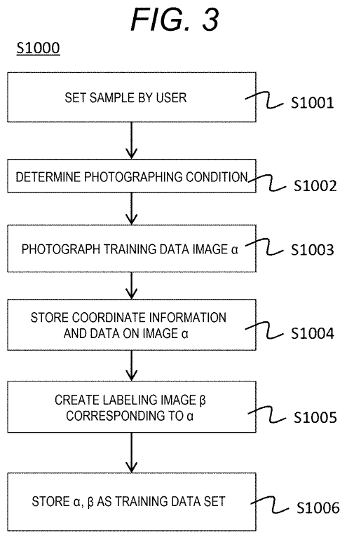

FIG. 3 is a diagram showing a detailed flow of the preparation S1000 of the training data set.

In a process S1001, a user sets a sample for creating the training data set in the texture structure analysis system. The sample is, for example, a piece of a prototype material. The user places the sample on the stage 119 of the observation device 2 to acquire an image of the texture of the material. In addition, data related to the sample, for example, data on a manufacturing process of the sample or separately acquired physical characteristics is input from the sample information input unit 130.

Examples of the information related to the manufacturing process of the sample include the following. The information is not limited to this, and may be freely defined by the user.
Ratio of elements indicating material composition
Heat treatment conditions (temperature, time, method)
Mixing conditions of material (number of times, time, method)
Catalyst (type, amount)

Examples of the information related to the physical characteristics of the sample include the following. The information is not limited to this, and may be freely defined by the user.
Mechanical characteristics. For example, hardness, spreadability, corrosion resistance, and the like.
Electrical characteristics. For example, electrical conductivity, resistivity.
Magnetic characteristics. For example, coercivity, permeability.
Thermal characteristics (specific heat, thermal conductivity).

The input data is stored in the sample information storage unit 123. Note that data related to the sample and data of the image of the sample can be associated with each other by the ID specifying the sample.

In a process S1002, photographing conditions of the sample are determined. The user inputs the photographing conditions of the observation device 2 from the input/output unit 129 to the overall control unit 102. For example, a magnification, a photographing location, and the number of photographed images. The overall control unit 102 sets parameters for photographing in each unit of the photographing condition setting unit 110 of the observation device 2 according to the input conditions.

In the beam control unit 111, intensity of an electron beam emitted from the electron beam generation unit 118, an irradiation time, a magnification depending on an electron optical system, scanning conditions, and the like are set. In the detector control unit 112, conditions such as a voltage supplied to the first signal detection unit 120 and the second signal detection unit 121 are set. Further, which detection units is to be operated is set. The stage control unit 113 sets an operation of the stage 119 and the supplied voltage.

In a process S1003, the texture structure analysis system photographs the sample set in the process S1001 under the conditions set in the process S1002. Photographing may follow operations of a general electron microscope. A signal detected by the first signal detection unit 120 is measured by the first signal acquisition unit 114, and a signal detected by the second signal detection unit 121 is measured by the second signal acquisition unit 115. The image forming unit 116 forms an image indicating a composition of the sample based on the measured signal.

In a process S1004, the image data is stored in the image data storage unit 125 for use as a training data image α. Normally a plurality of the training data images α are present. The coordinate information of the image on the sample is stored in the coordinate information storage unit 124 in association with the training data image α as coordinate data.

In a process S1005, the training data image α stored in the image data storage unit 125 is labeled, and a labeling image β is created.

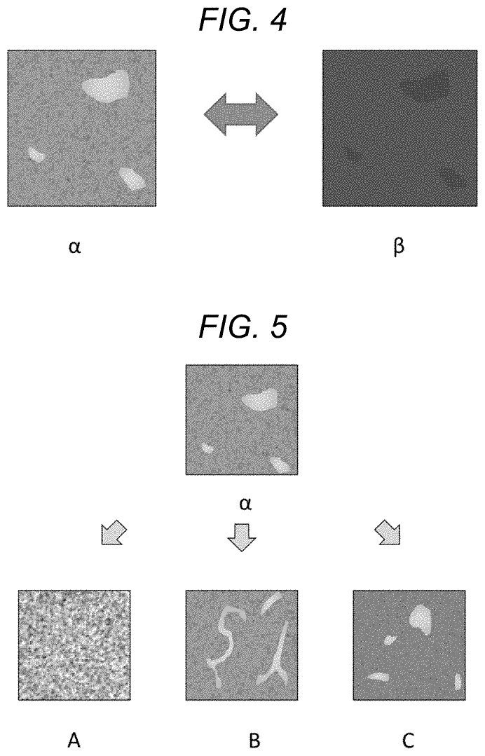

FIG. 4 is an image diagram showing an example of the training data image α and the labeling image β. The training data image α is an image photographed by the electron microscope, and the labeling image β labels each part of the training data image α. The labeling image is obtained by, for example, segmenting the image (region classification). Alternatively, a specific feature of the image is marked (extracted). In the example of FIG. 4, the labeling image β is classified into two regions. The classification of the regions is performed based on, for example, differences in a crystal state and the composition of the texture. Definition of the labeling can be freely determined. For example, by the texture data analysis unit 103 displaying the training data image α on the image display unit 133 so as to allow the user to visually observe the training data image α, the labeling image β can be created manually by the user.

In a process S1006, the created pair of the training data image α and the labeling image β is stored in the training data set storage unit 106 as the training data set. As described above, it is desirable that the training data set covers a wide range of image patterns that are may be processed, and that an appropriate correct answer is given to the pattern. However, when it is assumed that samples having similar material compositions are initially labeled as assumed in the present embodiment, an example is that the user prepares about 10 training data sets.

In the above description, the labeling is assumed to be performed by the user, but the labeling may also be automatically performed by, for example, an identifier using a properly learned hierarchical neural network or the like. As long as the labeling is appropriate, a labeling method is not particularly limited.

### <4. Automatically Identifiable Range Determination S2000>

The texture identifier 105 that performs the machine learning by using the training data set prepared in the process S1000 can expect appropriate processing within a range of an image covered by the training data set. However, there is a case where the appropriate processing cannot be expected for an image greatly changed from the image of the training data set.

FIG. 5 is an image diagram showing an example in which a texture image of the sample changes due to the manufacturing process changes. By changing the manufacturing process for the training data image α in FIG. 4, a crystal grain system changes (A), a shape of the phase changes (B), and brightness (contrast) changes (C). In such a case, the training data set used for the learning deviates from a sample to be identified, and there is a possibility that identification performance of the learned texture identifier 105 becomes insufficient. Therefore, in the present embodiment, a concept of the automatically identifiable range is introduced.

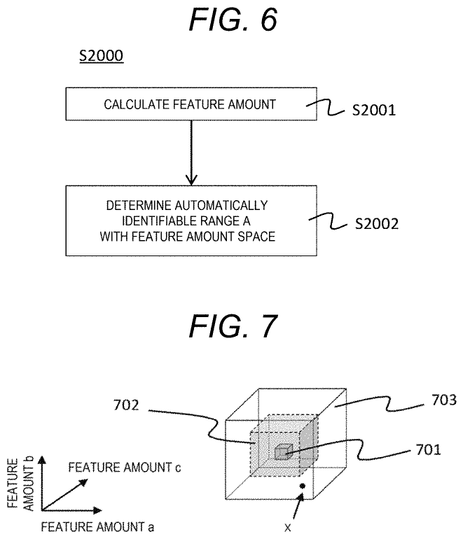

FIG. 6 is a detailed flow of the determination S2000 of the automatically identifiable range.

In a process S2001, the feature amount calculation unit 107 calculates a feature amount of an image. In the present embodiment, the image for calculating the feature amount is the labeling image β. The feature amount of the labeling image is also used later for analyzing the texture structure, and thus can be shared.

Examples of the information related to the feature amount of the labeling image include the following. The information is not limited to this, and one or a plurality of known feature amounts may be freely selected.
Number of phases
Area ratio of each phase
Area of each phase (average value, maximum value, minimum value, variation)
Maximum linear length of each phase (average value, maximum value, minimum value, variation)
Roundness count of each phase (average value, maximum value, minimum value, variation)

The roundness count is an index defined by an NIK method (Japan Foundry Association method) to evaluate degree of deformation of graphite particles, and is defined as “an index expressing a degree of spheroidization of graphite particles by an area ratio of each graphite particle to a circle whose diameter is a maximum linear length of the graphite particle”. Here, a representative example of the index indicating a shape is given.
Phase distance (average value, variation)
Area and size of hole (average value, maximum value, minimum value, variation)
Robustness of hole inherent in texture

The feature amount calculation unit 107 includes software for calculating the feature amount for each feature amount. Any of the above feature amounts can be obtained by processing the data of the labeling image by a known method.

The calculated feature amount is stored in the feature amount storage unit 127 together with correspondence with the labeling image β on which the calculation is based. Since normally a plurality of labeling images β are present, a plurality of the calculated feature amounts are present as well, and a distribution of the feature amounts is obtained statistically.

In a process S2002, the automatically identifiable range determination unit 108 determines the automatically identifiable range, and stores a result in the automatically identifiable range storage unit 109.

FIG. 7 is a conceptual diagram showing a concept of determining the automatically identifiable range based on the calculated feature amounts in the process S2002. Now, an example will be described in which a feature amount space is defined as three-dimensional and the automatically identifiable range is defined by three feature amounts A, B, C. However, the number of feature amounts to be used may be n (where n is any integer of 1 or more). When the number is small, an identification range may not be accurately grasped, and when the number is too large, a processing load increases. When the feature amount of the labeling image is used, the feature amount finally used for composition structure analysis may be shared.

In FIG. 7, a range of the feature amount of the labeling image β of the training data set is indicated by a training data set range 701. Here, the training data set range 701 is indicated by a rectangular parallelepiped defined by a maximum value and a minimum value of each feature amount. As long as the sample is a feature amount in this region, accuracy of the texture identifier 105 learned by using the training data set is considered to be high. However, as the sample moves away from this region, reliability of the identifier decreases.

FIG. 7 shows, as an automatically identifiable range 702, a range that is defined based on the training data set range 701 and can be automatically identified by the identifier. For example, when a feature amount of a new sample x is indicated by a point shown in FIG. 7, it means that the current identifier may not correctly identify the sample x.

Any method for defining the automatically identifiable range 702 may be adopted. For example, it is assumed that the training data set range 701 is a region expanded by a predetermined rule. In the example of FIG. 7, since the three-dimensional space is specified, an upper limit and a lower limit of the three feature amounts of the training data set range 701 are respectively expanded by predetermined amounts. An amount to be expanded can be determined by the user. When the expanded amount is large, the reliability of the identifier decreases, but a processing load for re-learning described later can be reduced. When the expanded amount is small, the result is opposite. The amount to be expanded may be determined according to a use of the system and required specifications. Note that, instead of expanding the training data set range 701 to the automatically identifiable range 702, the training data set range 701 may be reduced to the automatically identifiable range 702.

The automatically identifiable range determination unit 108 displays an image of the training data set range 701, for example, as shown in FIG. 7, on the image display unit 133, and the user can designate and determine the automatically identifiable range 702 from the input/output unit 129.

### <5. Texture Identifier Learning S3000>

In a process S3000, the overall control unit 102 performs learning on the texture identifier 105 by using the training data set stored in the training data set storage unit 106, that is, the training data image α and the labeling image (3.

The texture identifier 105 is a known identifier corresponding to supervised machine learning. For example, the hierarchical neural network or deep neural network (DNN), which is one type thereof, can be applied. Since a known method can be applied to the machine learning method itself, a detailed description is omitted.

When a plurality of types of labeling are performed, an identifier corresponding to the types of labeling may be learned. The texture identifier 105 generated by this learning is defined by the user as capable of appropriate identification within the automatically identifiable range 702 determined in the process S2000.

### <6. Texture Identification Execution S4000>

In the following, the texture identification is performed by using the texture identifier 105 learned in process S3000. A target of the texture identification is the data image other than the training data image. In the following example, an example in which the identification is performed in real time while an image is acquired by the observation device 2 is shown. However, the data image to be identified may be acquired in advance, or an image acquired by a third party may be obtained. In such a case, the recorded data image may be read out from a recording medium or the like to perform the processing.

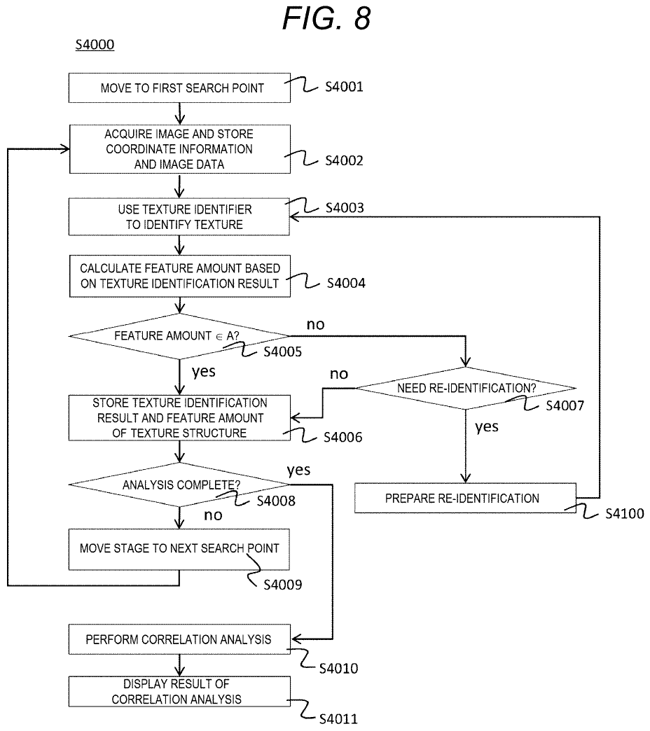

FIG. 8 is a flowchart showing details of an executing process S4000 of the texture identification. A sample from which a data image is to be acquired in advance is set on the stage 119, and setting of the photographing conditions and the like are the same as those described with reference to FIG. 3.

In a process S4001, an observation point is moved to a first search point of the sample from which the data image is to be acquired. For this purpose, an operation such as moving the stage 119 of the observation device 2 is performed, and basically a known method may be used.

In a process S4002, the observation device 2 acquires the data image and stores the coordinate information on the sample and the data image. When a plurality of samples are present, the sample number is also stored. These pieces data are sent to the texture structure analysis device 1 and stored in the image data storage unit 125 and the coordinate information storage unit 124 by the overall control unit 102.

In a process S4003, the texture identifier 105 identifies the data image read from the image data storage unit, and generates the labeling image.

In a process S4004, the feature amount calculation unit 107 calculates a feature amount based on the labeling image of a texture identification result.

In a process S4005, the overall control unit 102 determines whether the feature amount calculated in the process S4004 is within an automatically identifiable range A stored in the automatically identifiable range storage unit 109. When the feature amount is within the range A, the process proceeds to a process S4006, and when the feature amount is out of the range A, the process proceeds to a process S4007 of determining whether to perform re-identification.

In the process S4006, since the identification of the texture identifier 105 is recognized to be reliable in the determination of the process S4005, the texture identification result is stored in the texture identification result storage unit 126, and the feature amount of the texture structure is stored in the feature amount storage unit 127.

In a process S4008, when it is determined whether all planned search points are processed, and a result is no, the stage 119 is moved to a next search point in a process S4009, and the process returns to return to the process S4002, an image of the next search point is acquired, and thereafter, the process is repeated.

In a process S4007, since the identification of the texture identifier 105 is recognized to be unreliable in the determination of the process S4005, the overall control unit 102 inquires of the user about a final determination.

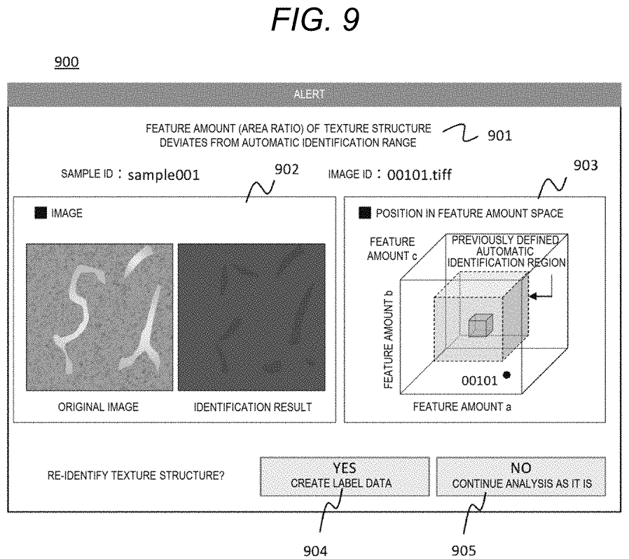

FIG. 9 is an example of a graphical user interface (GUI) display 900 displayed on the image display unit 133 by the alert output unit 134 according to an instruction from the overall control unit 102.

An alert 901 indicates which feature amount of the image is out of the automatically identifiable range, such as “FEATURE AMOUNT (AREA RATIO) OF TEXTURE STRUCTURE DEVIATES FROM AUTOMATIC IDENTIFICATION RANGE”. An ID of the sample and an ID of the image to be identified can also be displayed.

As shown in FIG. 9, in the process S4007, the labeling image (identification result) identified by the current texture identifier is displayed by displaying an image 902 aligned with the original image, so that the user can visually check whether the identification of the texture identifier 105 is correct.

Further, the user can intuitively grasp deviation from the automatically identifiable range by an image 903 that graphically indicates a position in the feature amount space. In the example of FIG. 9, it can be seen that a sample of an image ID00101 deviates from a range of a “PREVIOUSLY DEFINED AUTOMATIC IDENTIFICATION REGION”.

Referring to the information displayed as described above, the user can perform re-learning by the texture identifier 105 with a “CREATE LABEL DATA” button 904, or can press a “CONTINUE ANALYSIS AS IT IS” button 905 to select and enter whether to continue the processing with the current texture identifier 105. The determination input unit 132 receives the input result and proceeds to a re-identification preparation process S4100 when the re-learning is performed, or proceeds to the process S4006 when continuing as it is. The re-identification preparation process S4100 will be described in the next section.

When the processing of the planned search points is completed and the texture structure feature amount is stored in the feature amount storage unit 127, a correlation analysis S4009 can be performed. In the correlation analysis S4009, the correlation analyzer 128 analyzes a correlation between the feature amount of the texture structure in the feature amount storage unit 127, characteristic data in the sample information storage unit, and the manufacturing process data. As described at beginning of the embodiment, by analyzing the correlation between the data, a guide as to which the manufacturing process should be changed to obtain desired characteristics can be obtained. Since a known method can be applied to the correlation analysis, a detailed description is omitted.

In process S4010, the analysis result display unit 135 displays a result of the correlation analysis on the image display unit 133 and presents the result to the user. Based on the results of the correlation analysis, the user can obtain a guide for improving the material composition and the process, and can further prototype new samples.

### <7. Re-Identification Preparation Process S4100>

In re-identification preparation process S4100, the texture identifier 105 performs re-learning for re-identifying the data image. For this purpose, a training data set obtained by using electron microscope images is added. The following can be considered as a training data set to be added.

For example, as a training data image of the training data set to be added, a sample obtained by photographing a data image having a feature amount deviating from the automatic identification range and an image of a sample created by a similar manufacturing process are used. That is, a predetermined number of data images are photographed from a new sample and are used. In one example, a training data set is added by adding one training data set and a labeling image from the data image having the feature amount deviating from the automatic identification range to about ten training data sets prepared in advance.

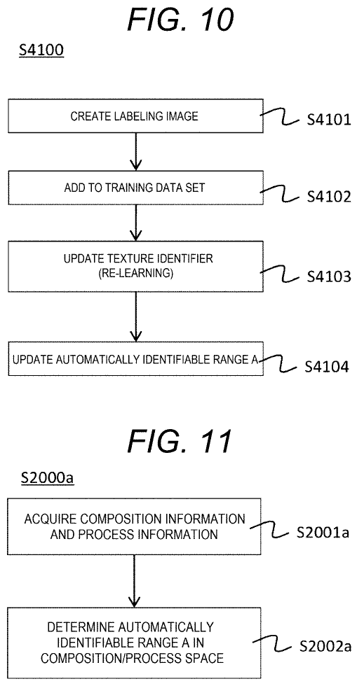

FIG. 10 is a diagram showing a detailed flow of the re-identification preparation process S4100.

In a process S4101, the labeling image is created for the extracted data image. The creation of the labeling image may be the same as the process S1005 described in FIG. 3.

In a process S4102, the extracted data image and the labeling image thereof are stored in the training data set storage unit 106 as the training data set. The process may be the same as the process S1006 described in FIG. 3.

In a process S4103, the texture identifier 105 is re-learned. The process may be the same as the process S3000 described in FIG. 2. At this time, the training data set stored in process S4102 is added to the existing training data set, and the texture identifier 105 is learned. In this case, an application range of the texture identifier 105 is considered to be widened. Alternatively, the texture identifier 105 can be learned by using only the training data set stored in the process S4102. In this case, the application range of the texture identifier 105 is considered to be changed. In any case, it can be applied to a new sample.

When a plurality of types of the texture identifiers are present, only the texture identifier in which the feature amount deviates from the automatic identification range need to be re-learned.

In process S4104, the automatically identifiable range of the texture identifier 105 is updated. The process may be the same as the process S2000 described in FIG. 6.

According to the first embodiment, the automatic identification range is defined based on the feature amount of the labeling image of the training data set. When the feature amount of the labeling image of the image to be identified deviates from the automatically identifiable range, the user can be given an opportunity to re-learn the texture identifier 105 by the determination S4005.

### Second Embodiment

In the first embodiment, the automatically identifiable range 702 is defined by using the feature amount of the labeling image β. However, the automatically identifiable range can be defined by using the feature amount of the training data image α instead of the feature amount of the labeling image β. This is because the labeling image β corresponds to output of the texture identifier 105 and the training data image α corresponds to input of the texture identifier 105, and these are considered to correspond to a configuration of the texture identifier 105.

The basic configuration is the same as in FIG. 1 and the basic processes is the same as in FIG. 2, but the following description focuses on differences.

In automatically identifiable range determination S2000 (FIG. 6), in the feature amount calculation S2001, the feature amount is calculated based on the training data image α stored in the training data set storage unit 106. Further, in automatically identifiable range determination S2000, the automatically identifiable range is defined by the feature amount of the training data image α.

Examples of the information related to the feature amount of the training data image include the following. The information is not limited to this, and one or a plurality of known feature amounts may be freely selected.
Frequency (average value, maximum value, minimum value, variation)
Brightness value (average value, maximum value, minimum value, variation)
Entropy
Structural patterns and textures

A function for obtaining the feature amount of the training data image is prepared in the feature amount calculation unit 107 in addition to a function of obtaining the feature amount of the sampling image.

In texture identification execution S4000 (FIG. 8), in addition to the process S4004 of calculating the feature amount based on the texture identification result, a process of calculating the feature amount based on the data image is performed. In the determination process S4005, the feature amount of the data image is compared with the automatically identifiable range.

In re-identification preparation process S4100 (FIG. 10), in the automatic identification range updating process S4104, similarly to the process S2002, the automatically identifiable range is updated with the feature amount of the training data image α.

In the above description, it is essential to obtain the feature amount of the labeling image for analyzing the sample. However, if an object is only for re-learning the texture identifier, the feature amount of the labeling image is not necessary, and all the processes using the feature amount of the labeling image may be replaced with the processes using the feature amount of the training data image.

A training data creation system for the object of re-learning the texture identifier can be configured as a system including: a unit for calculating a size of a created first training data region by using a texture image of a predetermined region, a unit for calculating a range of a search area that can be identified by the first training data set (feature amount, distance), based on the size of the training data region, a unit for determining whether a feature amount deviates from the range of the search area, based on a feature amount in a search area of an analysis target, or a distance between the search area of the analysis target and the first training data area, and a unit for newly creating a second training data set by using a texture image of the analysis target, when the feature amount of the texture image of the analysis target deviates from the range of the feature amount of the image that can be identified.

According to the second embodiment, the automatic identification range is defined based on the feature amount of the training data image of the training data set. When the feature amount of the image to be identified deviates from the automatically identifiable range, the user can be given an opportunity to re-learn the texture identifier 105 by the determination S4005.

### Third Embodiment

In the first embodiment and the second embodiment, the automatically identifiable range 702 is defined by using the feature amount of the image. However, the automatically identifiable range can be defined by using the conditions of the manufacturing process instead of the feature amount of the image. This is because the image obtained by photographing the material is correlated with the manufacturing process of the material on which the image is based.

The basic configuration is the same as in FIG. 1 and the basic processes is the same as in FIG. 2, but the following description focuses on differences.

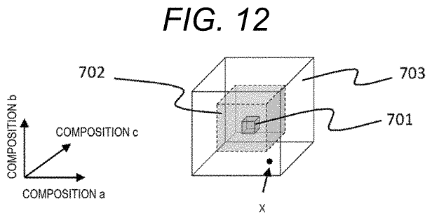

FIG. 11 is a diagram showing a detailed flow of determination S2000a of the automatically identifiable range according to the second embodiment. This is a process replacing the determination S2000 of the automatically identifiable range in the first embodiment.

In a process S2001a, composition conditions of the material and at least one of processing conditions such as a heat treatment and a pressure treatment performed for manufacturing the material are acquired. Since information on these samples is stored in the sample information storage unit 123, data corresponding to the training data image of the training data set is acquired.

In a process S2002a, an automatically identifiable range in a composition/process space is determined by using the acquired data.

FIG. 12 is a conceptual diagram showing a concept of determining the automatically identifiable range based on information on the composition/process in the process S2002a. Now, an example will be described in which the composition/process space is defined as three-dimensional composition space and the automatically identifiable range is defined by three feature amounts A, B, C. The number of dimensions to be used may be one or more. When the number is small, an identification range may not be accurately grasped, and when the number is too large, a processing load increases. The composition space is used in this example, but the dimension of the process condition may be used instead or in addition to this. As the process conditions, for example, anyone of heat treatment temperature and heat treatment time can be selected.

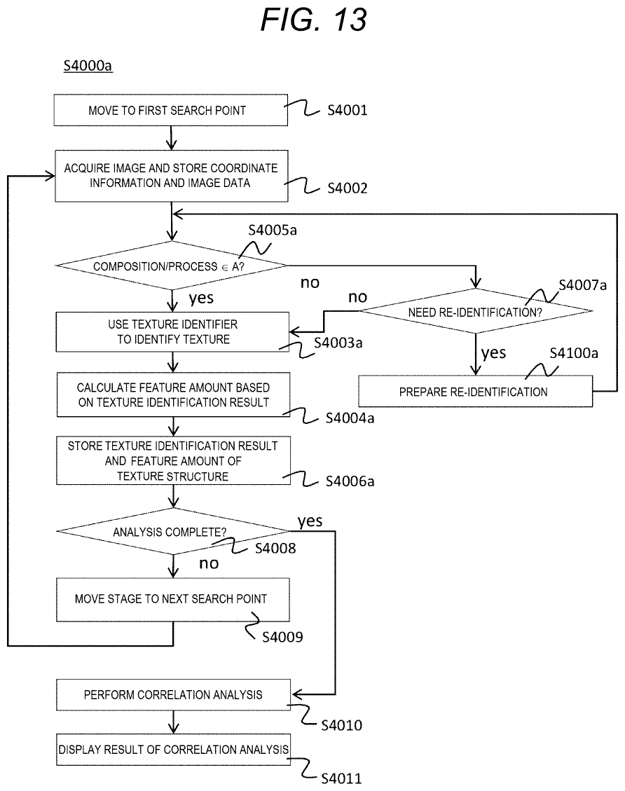

FIG. 13 is a flowchart showing details of an executing process S4000a of the texture identification. This is a process replacing the determination S4000 of the automatically identifiable range in the first embodiment. The difference is that an order of determination S4005a of the automatically identifiable range in the composition/process space is advanced. This is because information for making the determination can be acquired immediately from the sample information storage unit 123. A texture identification process S4003a and a feature amount calculation process S4004a are performed after the determination S4005a.

In the above description, it is essential to obtain the feature amount of the labeling image for analyzing the sample. However, if only the re-learning of the texture identifier is the object, the feature amount of the labeling image is not required.

According to the third embodiment, the automatic identification range is defined based on the manufacturing process conditions of the material on which the training data set is based. When the manufacturing process of the image to be identified deviates from the automatically identifiable range, the user can be given the opportunity to re-learn the texture identifier 105 by the determination S4005a.

### Fourth Embodiment

In the re-identification preparation process S4100 of the first embodiment and FIG. 8, in order to re-identify the data image, a training data set based on an electron microscope image is added, the texture identifier 105 is re-learned, and the same process is continued. In the device of the first embodiment and FIG. 1, it is assumed that the first signal detection unit 120 is a detector for the electron microscope image, and the second signal detection unit 121 is a detector capable of acquiring other information such as EDX, EBSD, and EPMA. Since the second signal detection unit 121 can obtain information such as mapping information of content amount and crystallinity of elements, crystal orientation, and the like, in addition to the information from the first signal detection unit 120, the information from the second signal detection unit 121 is used, so that the labeling image can be generated even when the texture identifier 105 deviates from the automatically identifiable range.

For acquiring information, a sample that is based on an existing training data set can also be used. In the device as shown in FIG. 1, since signals of the first signal detection unit 120 and the second signal detection unit 121 can be acquired simultaneously for the same visual field, for example, the electron microscope image and an EDX image are acquired. Then, for example, (1) an object (contour) is detected by the electron microscope image from the first signal detection unit 120, (2) what element each object is made of is acquired from the EDX image of the second signal detection unit 121, and (3) processing to identify (estimate) the texture is performed. In the texture identification, for example, it is estimated that the structure is SiO₂ because Si and O are main components. By such a process, for example, when the sample is a metal or the like, how regions having uniform composition, crystal structure and crystal orientation are distributed can be examined. The above processes (1), (2), and (3) can be performed by a general software, but a dedicated identifier may be separately used.

When an existing sample is used (other samples may be used as well), for example, the EDX image acquired by the second signal detection unit 121 is acquired in addition to a normal electron microscope image. For example, a surface image can be observed with the electron microscope image, but the content amount of the elements can be reflected in the image with EDX. In the fourth embodiment, when determination in determination S4007 of the first embodiment and FIG. 8 is yes, the texture identifier 105 is not re-learned and used continuously, but as described in (1), (2), and (3) above, the process shifts to the analysis using the signals of the first signal detection unit 120 and the second signal detection unit 121.

### Fifth Embodiment

As described in the first embodiment, each part of the texture structure analysis device 1 and the observation device 2 in FIG. 1 may be independent devices. Further, the processes of S1000 to S4000 in FIG. 2 can be performed separately and independently by separate devices. For example, an image may be photographed by the observation device 2 at another location, the data image may be carried to a location of the texture structure analysis device 1 by the recording medium, and stored in the image data storage unit 125 from the input/output unit 129. In that case, the process S4001 and the process S4002 of the process of S4000 (FIG. 1) can be replaced by reading the image data from the image data storage unit 125. Further, the process S4003 and the process S4004 can be performed by other devices. However, in that case, when the texture identifier 105 is re-learned, the process is repeated.

What is claimed is:

1. An information processing system comprising:
an identifier configured to output an identification result with an image as input;
an automatically identifiable range storage unit configured to store an identifiable range of the identifier defined by numerical values in n (n is an integer of 1 or more) dimensions;
an acquisition unit configured to acquire the numerical values corresponding to the image;
a control unit configured to compare the numerical values acquired by the acquisition unit and the identifiable range; and
an alert output unit configured to output an alert when the control unit determines that the numerical values acquired by the acquisition unit deviate from the identifiable range.

2. The information processing system according to claim 1, wherein
the acquisition unit is a feature amount calculation unit configured to calculate a feature amount of the identification result,
the numerical values are the feature amount of the identification result, and
the identifiable range is defined by the feature amount of the identification result.

3. The information processing system according to claim 1, wherein
the acquisition unit is a feature amount calculation unit configured to calculate a feature amount of the image,
the numerical values are the feature amount of the image, and
the identifiable range is defined by the feature amount of the image.

4. The information processing system according to claim 1, further comprising:
a sample information storage unit configured to store at least one of a composition condition of a material and a processing condition applied for manufacturing the material, which are related to a sample from which the image is acquired, wherein
the acquisition unit is configured to acquire at least one of the composition condition and the processing condition from the sample information storage unit,
the numerical values are at least one of the composition condition and the processing condition, and
the identifiable range is defined by at least one of the composition condition and the processing condition.

5. The information processing system according to claim 1, wherein
the identifier is an identifier capable of performing supervised machine learning, and
includes an automatically identifiable range determination unit configured to determine the identifiable range of the identifier based on numerical values corresponding to a training data set used for the machine learning of the identifier.

6. The information processing system according to claim 5, further comprising:
an image display unit and an input/output unit, wherein
the automatically identifiable range determination unit is configured to:
display, on the image display unit, an image indicating a range of the numerical values corresponding to the training data set used for the machine learning, and
determine an identifiable range of the identifier based on an instruction input from the input/output unit corresponding to the display.

7. The information processing system according to claim 5, further comprising:
an image display unit and an input/output unit, wherein
the alert output unit is configured to:
display, on the image display unit, the image and the identification result of the identifier, and
allow determination of whether to continue using the identifier based on an instruction input from the input/output unit corresponding to the display.

8. An information processing method for identifying an image by using an identifier learned by supervised machine learning, the information processing method comprising:
a first step of storing an identifiable range of the identifier defined by numerical values in n (n is an integer of 1 or more) dimensions, and acquiring the numerical values corresponding to the image;
a second step of comparing the acquired numerical values with the identifiable range; and
a third step of notifying a user when it is determined that the acquired numerical values deviate from the identifiable range.

9. The information processing method according to claim 8, wherein
the identifiable range of the identifier is determined based on a range of the numerical values corresponding to a training data set used for learning of the identifier.

10. The information processing method according to claim 9, wherein
the training data set includes a training image and a training labeling image obtained by labeling the training image, and
the identifiable range of the identifier is determined based on a range of a feature amount obtained from the training labeling image.

11. The information processing method according to claim 10, wherein
in the first step, a feature amount of a labeling image obtained by the identifier identifying the image is acquired as the numerical values, and
in the second step, the feature amount of the labeling image and the identifiable range are compared.

12. The information processing method according to claim 10, wherein
in the third step, the image and a labeling image obtained by the identifier identifying the image are displayed to a user.

13. The information processing method according to claim 10, wherein
in the third step, based on a response from the user, the identifier is re-learned via a training data set obtained via a new training image or a training data set obtained by adding the new training image.

14. The information processing method according to claim 8, wherein
after the notification in the third step is received, the image is identified by using information obtained by an observation unit different from a unit that acquires the image.

15. The information processing method according to claim 9, wherein
the training data set includes a training image obtained by photographing a sample and a training labeling image obtained by labeling the training image, and
the identifiable range of the identifier is determined based on at least one of a range of a feature amount obtained from the training image, a range of a composition condition of the sample, and a range of a manufacturing condition of the sample.
